(19) United States
(12) Patent Application Publication
(10) Pub. No.: US 2026/0163285 A1
(43) Pub. Date: Jun. 11, 2026

(54) CONNECTOR

(71) Applicant: SUMITOMO WIRING SYSTEMS, LTD., Mie (JP)

(72) Inventors: Keisuke KANEMURA, Mie (JP); Norihito HASHIMOTO, Mie (JP)

(21) Appl. No.: 19/404,451

(22) Filed: Dec. 1, 2025

(30) Foreign Application Priority Data
Dec. 11, 2024 (JP) 2024-216136

(51) Int. Cl. H01R 13/426; H01R 13/6599

(52) U.S. Cl. CPC H01R 13/426; H01R 13/6599

(57) ABSTRACT

A retainer includes: a base portion that is placed in a mounting hole through an opening in one surface of a housing; a pair of side portions that protrude from the base portion and face a pair of side surfaces of the housing; locked portions that are provided on the pair of side portions; and a retaining portion that is positioned between the pair of side portions in the left-right direction and protrudes from the base portion. The base portion includes a pair of jig engagement portions at positions on both left and right sides of an inner surface on the cavity side. The housing includes a pair of jig receiving portions, which face the pair of jig engagement portions, at positions on both sides in the left-right direction on the one surface.

### CROSS-REFERENCE TO RELATED APPLICATIONS

This application is based on and claims priority from Japanese Patent Application No. 2024-216136, filed on December 11, 2024, with the Japan Patent Office, the disclosure of which is incorporated herein in its entirety by reference.

### TECHNICAL FIELD

### The present disclosure relates to a connector.

### BACKGROUND

A connector disclosed in Japanese Patent Laid-open Publication No. 2022-069162 is a high-frequency connector equipped with an inner terminal (hereinafter referred to simply as a "terminal"), an inner housing (hereinafter referred to simply as a "housing"), and a female-side spacer (hereinafter referred to as a "retainer"). The housing includes an inner terminal accommodating chamber (hereinafter referred to simply as a "cavity") and a spacer insertion hole (hereinafter referred to as a "mounting hole") that intersects the cavity and is open in a lower surface of the housing. The terminal is accommodated in the cavity of the housing from the rear. The retainer is accommodated in the mounting hole of the housing from below. The retainer locks the terminal at a full locking position and prevents the terminal from coming out from the cavity to the rear. The housing includes locking portions (see Japanese Patent Laid-open Publication No. 2022-069162) for provisional locking and for full locking on a pair of side surfaces that face outward to the left and right. The retainer includes locked portions, which can be locked by the locking portions, on a pair of side portions that face the side surfaces. By locking the locked portions by the locking portions, the retainer is held on the housing at the provisional locking position and the full locking position.

### SUMMARY

In the configuration described above, when the retainer is moved from the full locking position to the provisional locking position, it is necessary to first release the locking between the locking portions and the locked portions in the full locking. As one example, it is possible to insert the front end of a jig such as a flat-head screwdriver, between a side portion of the retainer and a side surface of the housing and twist the jig to move the side portion away from the side surface so as to release the locking between the locking portion and the locked portion. However, in this case, there is a risk that the locked parts of the locking portion and the locked portion will be damaged by the front end of the jig. To address this, it is possible to operate the jig at a position away from the side portion so that the front end of the jig does not come into contact with the locked parts. However, in this case, there is concern that the operating force of the jig may not be sufficiently transmitted to the locked parts, so that the releasing operation does not proceed smoothly.

For this reason, it is an object of the present disclosure to provide a connector where locking of a retainer can be easily released from a housing and a jig can be prevented from coming into contact with locked parts of the housing and the retainer when releasing a locked state.

A connector according to an aspect of the present disclosure is a connector including a terminal, a housing that accommodates the terminal, and a retainer that is attached to the housing, wherein the housing includes: a cavity that extends in a front-rear direction, a mounting hole that intersects the cavity and is open in one surface of the housing, and locking portions provided on a pair of side surfaces of the housing that intersect the one surface and face left and right directions, the terminal is disposed in the cavity, the retainer includes: a base portion that is placed in the mounting hole through the opening in the one surface; a pair of side portions that protrude from the base portion and face the pair of side surfaces; locked portions that are provided on the pair of side portions; and a retaining portion that is positioned between the pair of side portions in the left-right direction and protrudes from the base portion, the locking portions lock the locked portions, the retainer is held on the housing, and the retaining portion locks the terminal to prevent the terminal from coming out from the cavity to the rear, the base portion includes a pair of jig engagement portions at positions on both left and right sides of an inner surface on the cavity side, and the housing includes a pair of jig receiving portions, which face the pair of jig engagement portions, at positions on both sides in the left-right direction on the one surface.

According to the above aspect of the present disclosure, it is possible to provide a connector where locking of a retainer can be easily released from a housing and a jig can be prevented from coming into contact with locked parts of the housing and the retainer when releasing a locked state.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector according to a first embodiment.

FIG. 2 is a sectional side view of the connector according to the first embodiment.

FIG. 3 is a cross-sectional view of the connector according to the first embodiment along a line A-A in FIG. 2.

FIG. 4 is a bottom view of a housing in the connector according to the first embodiment.

FIG. 5 is a perspective view of a retainer in the connector according to the first embodiment as seen from the front.

FIG. 6 is a perspective view of the retainer in the connector according to the first embodiment as seen from the rear.

FIG. 7 is a sectional side view of a state where the retainer in the connector according to the first embodiment is held on the housing at a full locking position and engagement of a front end of a jig with a locking engagement portion from a recess in a jig receiving portion is depicted in enlargement.

FIG. 8 is an enlarged sectional side view of a state where, for the connector according to the first embodiment, movement of the retainer from the state in FIG. 7 relative to the housing to a provisional locking position.

FIG. 9 is a perspective view of a state where, for the connector according to the first embodiment, the retainer is held on the housing at the provisional locking position as seen from the rear and below.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Outline of Embodiments of the Present Disclosure

Embodiments of the present disclosure will first be listed and described in outline.

1 A connector according to an aspect of the present disclosure is a connector including a terminal, a housing that accommodates the terminal, and a retainer that is attached to the housing, wherein the housing includes: a cavity that extends in a front-rear direction, a mounting hole that intersects the cavity and is open in one surface of the housing, and locking portions provided on a pair of side surfaces of the housing that intersect the one surface and face left and right directions, the terminal is disposed in the cavity, the retainer includes: a base portion that is placed in the mounting hole through the opening in the one surface; a pair of side portions that protrude from the base portion and face the pair of side surfaces; locked portions that are provided on the pair of side portions; and a retaining portion that is positioned between the pair of side portions in the left-right direction and protrudes from the base portion, the locking portions lock the locked portions, the retainer is held on the housing, and the retaining portion locks the terminal to prevent the terminal from coming out from the cavity to the rear, the base portion includes a pair of jig engagement portions at positions on both left and right sides of an inner surface on the cavity side, and the housing includes a pair of jig receiving portions, which face the pair of jig engagement portions, at positions on both sides in the left-right direction on the one surface.

According to the configuration of (1) above, locking of the locking portions and the locked portions can be released by placing a jig on the jig receiving portions and engaging the front end of the jig with the jig engagement portions. In particular, since the engagement position of the front end of the jig is on the base portion and not the side portions, it is possible to prevent the front end of the jig from coming into contact with the locked parts of the locking portions and the locked portions. In addition, since the engagement position of the front end of the jig is a position on the base portion near the pair of side portions, the operating force of the jig can be efficiently transmitted to the locked parts, which makes it easy to release the locking of the retainer to the housing.

2 In the connector according to (1) above, the pair of jig receiving portions preferably include jig contact portions at a corner of a stepped portion that protrudes from the one surface.

According to the configuration of (2) above, the jig can be rotated using the principle of leverage with the jig contact portions as the pivot. As a result, it is possible to release the locking of the retainer more easily.

3 In the connector according to (1) above, the housing preferably includes a lance that is elastically deformable and locks the terminal, and the lance preferably faces the mounting hole and is disposed between the pair of jig receiving portions in the left-right direction.

According to the configuration of (3) above, since the front end of the jig can be prevented from coming into contact with the lance, the lance can function properly.

4 In the connector according to any one of (1) to (3) above, the terminal is preferably a shielded terminal including an inner conductor, a dielectric that accommodates the inner conductor, and an outer conductor that accommodates the dielectric, and the retaining portion preferably locks the outer conductor.

According to the configuration of (4) above, the locking portion is less likely to break, and since the retainer can be stably locked onto the housing, it is possible to suppressing positional fluctuations in the outer conductor locked by the retaining portion, which ensures that the terminal has the desired shielding properties.

### Detailed Embodiments of the Present Disclosure

Specific examples of the present disclosure will be described below with reference to the accompanying drawings. Note that the present invention is not limited to the examples given here, but is indicated by the claims, and is intended to include all changes within the meaning and scope of the claims and their equivalents.

### First Embodiment

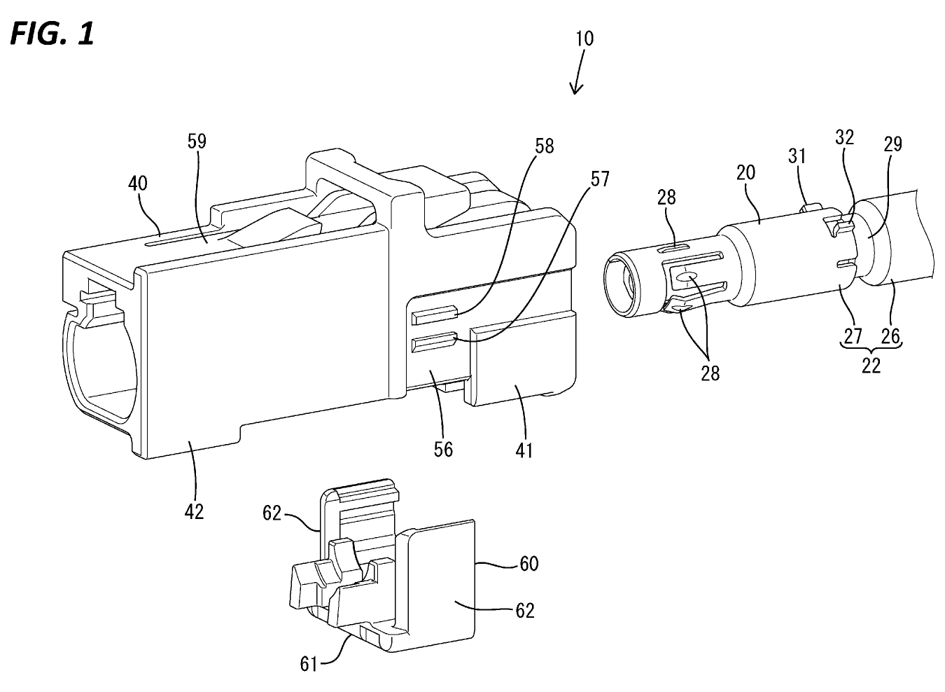

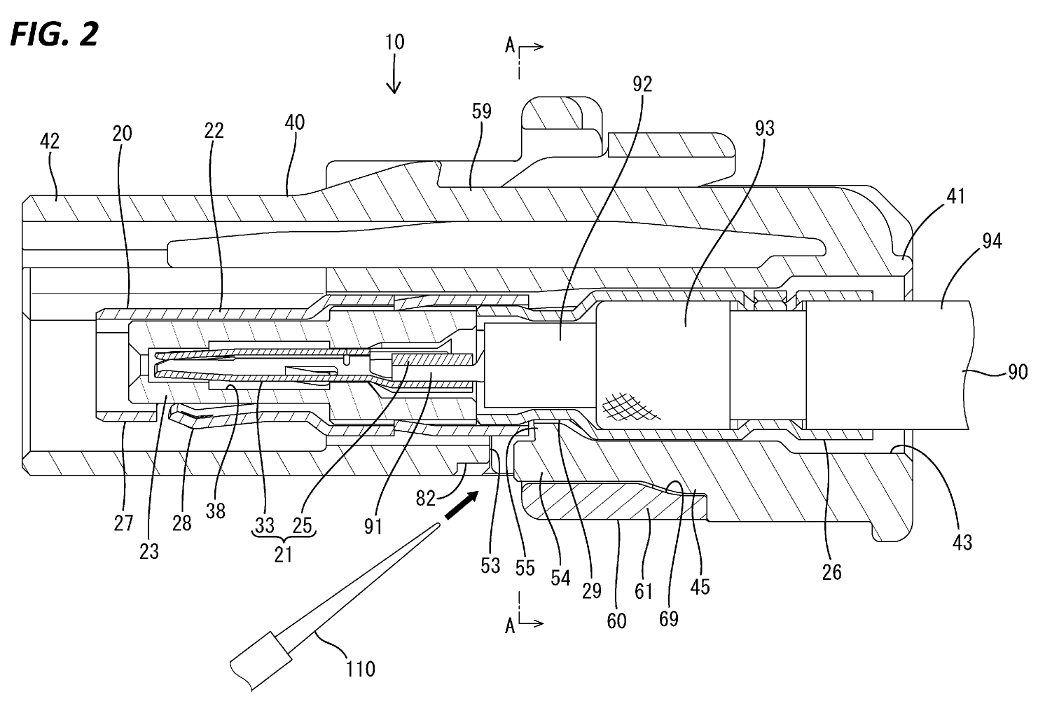

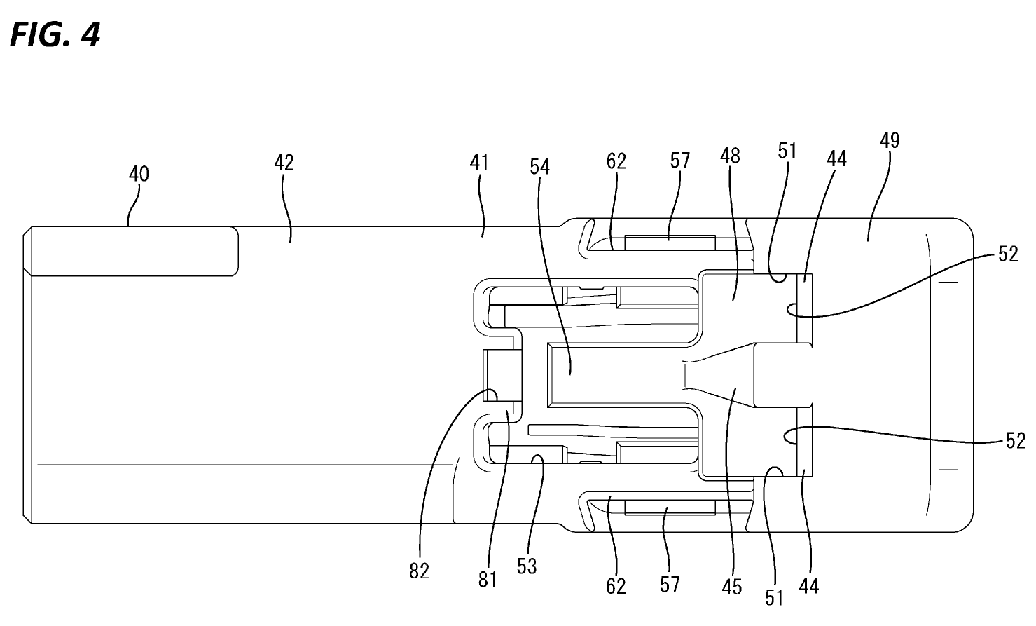

A connector 10 according to a first embodiment is a so-called "shielded connector". As depicted in FIG. 1, the connector 10 includes a terminal 20, a housing 40 that accommodates the terminal 20, and a retainer 60 that prevents the terminal 20 from coming out from the housing 40. As depicted in FIG. 2, the terminal 20 is connected to an end portion of a shielded wire 90. The housing 40 is designed to be capable of mating with a mating connector (not illustrated). Note that in the following description, for the expression "front-rear direction", the "front" is to the side of the housing 40 that mates with the mating connector. The "up-down" direction is based on the up-down direction in the respective drawings aside from FIG. 4. However, the bases for such directions in this specification do not necessarily match with base directions in a state where the connector 10 is actually mounted in a vehicle or the like (not illustrated).

### Terminal 20 and Shielded Wire 90

The terminal 20 as a whole has an elongated shape that extends in the front-rear direction. As depicted in FIG. 2, the terminal 20 includes an inner conductor 21, an outer conductor 22, and a dielectric 23. The inner conductor 21 is formed by bending a conductive metal plate, for example. The inner conductor 21 has a connecting portion 33, which is tubular, and a crimped portion 25, which is continuous with the rear of the connecting portion 33. The connecting portion 33 is connected to a mating inner conductor (not illustrated). The crimped portion 25 is connected by crimping to a core wire 91 at the end portion of the shielded wire 90. The shielded wire 90 is a so-called coaxial cable, and has an insulating covering 92 that surrounds the outer circumference of the core wire 91, a braided wire 93 in the form of a mesh tube that surrounds the outer circumference of the covering 92, and an insulating sheath 94 that surrounds the outer circumference of the braided wire 93. The core wire 91 has a function of transmitting high-frequency signals. The braided wire 93 has a function of shielding against electromagnetic waves.

The outer conductor 22 is formed by bending a conductive metal plate, for example. As depicted in FIGS. 1 and 2, the outer conductor 22 includes a first outer conductor 26 and a second outer conductor 27 which are separate from each other. The first outer conductor 26 and the second outer conductor 27 are both cylindrical in shape with their axes oriented in the front-rear direction. A front end of the first outer conductor 26 is fitted inside the rear end of the second outer conductor 27. The first outer conductor 26 and the second outer conductor 27 are connected by welding, such as spot welding, performed at their respective parts that are fitted together.

As depicted in FIG. 1, a plurality of contact portions 28 are formed at intervals around the circumferential direction on the outer circumferential surface of a front portion of the second outer conductor 27. A mating outer conductor (not illustrated) is fitted from the front onto the front portion of the second outer conductor 27. The outer conductor 22 and the mating outer conductor are electrically connected when the contact portions 28 come into contact with an inner circumferential surface of the mating outer conductor. The rear end of the first outer conductor 26 is connected to the braided wire 93 of the shielded wire 90 by crimping. The first outer conductor 26 has a constricted portion 29 that narrows inward in the radial direction between the rear end that is crimped to the braided wire 93 of the shielded wire 90 and the front end that is fitted into the second outer conductor 27.

As depicted in FIG. 1, a first convex portion 31 and a second convex portion 32 are formed to protrude outward in the radial direction on the rear end of the second outer conductor 27 (which corresponds to an intermediate portion in the front-rear direction of the outer conductor 22). The first convex portion 31 and the second convex portion 32 are provided side by side on both the left and right sides (that is, both sides in the circumferential direction) of the upper end of the outer circumferential surface of the second outer conductor 27.

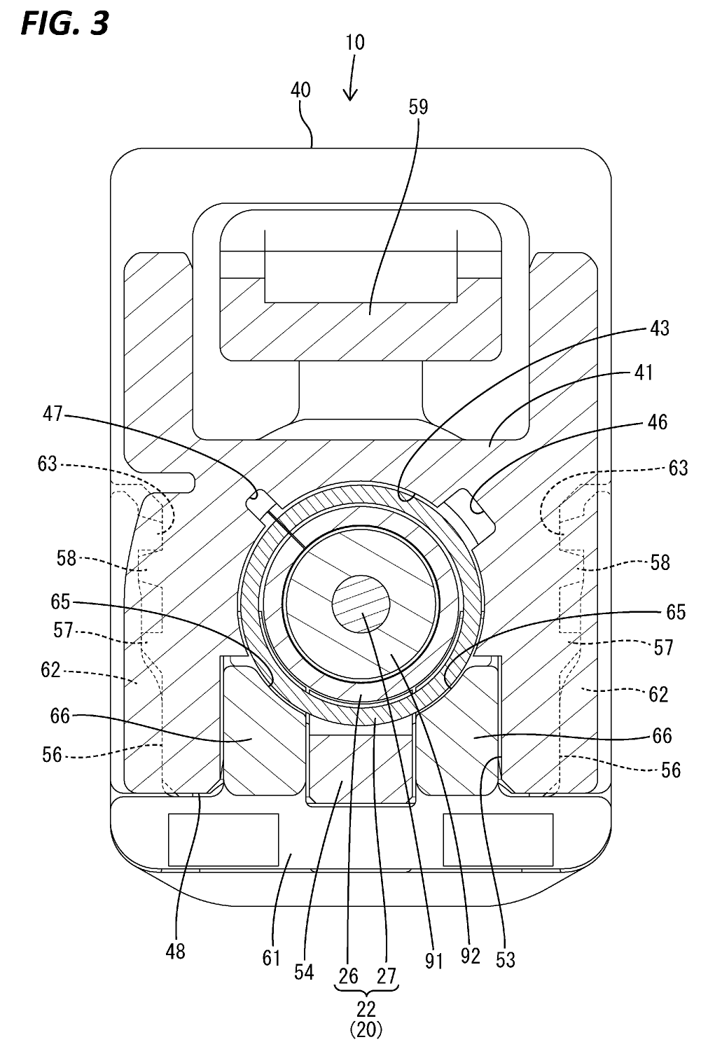

The first convex portion 31 fits into a first channel 46 (see FIG. 3) of the housing 40, which will be described later. If the terminal 20 is positioned incorrectly in the circumferential direction during insertion into the housing 40, the first convex portion 31 will not positionally coincide with the first channel 46 and will come into contact with a facing wall surface of the housing 40. By doing so, the terminal 20 is prevented from being inserted into the housing 40 in an incorrect posture. The second convex portion 32 fits into a second channel 47 of the housing 40, which will be described later. Opposite side surfaces in the circumferential direction of the second convex portion 32 come into contact with the inner surfaces of the second channel 47 in the circumferential direction, which prevents the terminal 20 from rotating around its axis inside the housing 40.

The dielectric 23 is molded from an electrically insulating synthetic resin material. The dielectric 23 as a whole is formed into a TUBULAR shape with its axis oriented in the front-rear direction. As depicted in FIG. 2, the dielectric 23 has an accommodating hole 38 that extends in the axial direction. The inner conductor 21 is inserted into the accommodating hole 38 of the dielectric 23 from the rear and is accommodated therein. The shielded wire 90 is disposed to the rear of the dielectric 23, except for the front end of the core wire 91 that is connected to the inner conductor 21. Electrical insulation between the inner conductor 21 and the outer conductor 22 is maintained by the dielectric 23 interposed between them.

### Housing 40

The housing 40 is molded from an electrically insulating synthetic resin material. As depicted in FIGS. 1 and 2, the housing 40 includes a housing main body 41 and a hood portion 42 that protrudes forward from the housing main body 41. A mating connector fits inside the hood portion 42. A locking arm 59 that is elastically deformable is formed so as to protrude from the top surface of the housing 40. The locking arm 59 extends in the front-rear direction from the hood portion 42 to the housing main body 41. The locking arm 59 has a function of locking the mating connector to keep the connector 10 and the mating connector in a mated state. As depicted in FIG. 2, the housing main body 41 includes a cavity 43 that extends in the front-to-rear direction. The front end of the cavity 43 is open at an inner end surface (that is, a surface that faces forward at the rear) of the hood portion 42. The terminal 20 is inserted into the cavity 43 from the rear and accommodated therein.

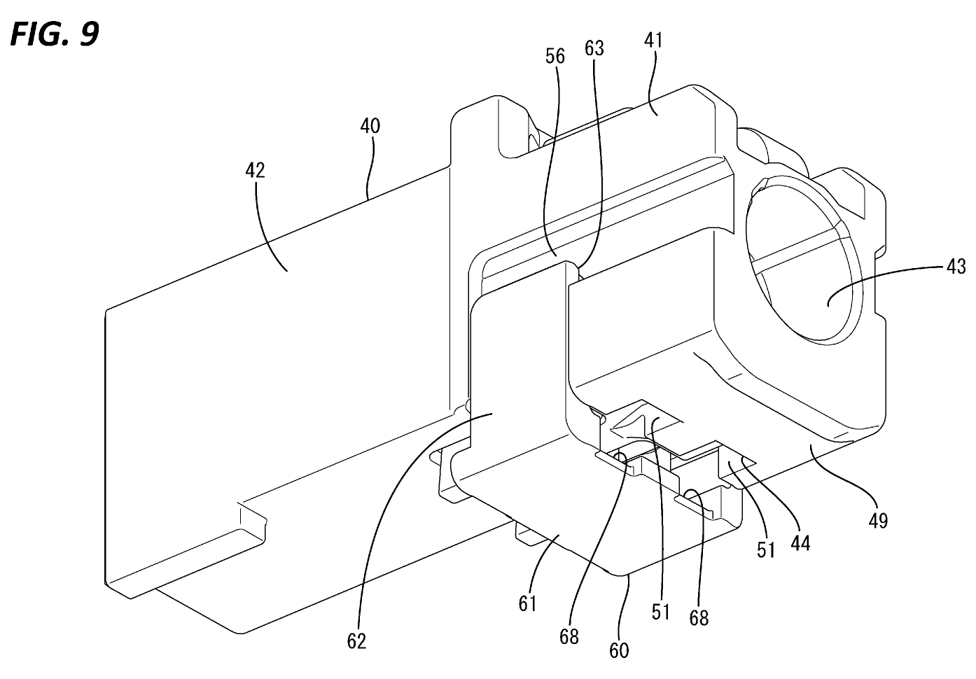

As depicted in FIGS. 3 and 9, the cross-sectional shape of the inner circumferential surface of the cavity 43 (that is, the shape of the opening) is circular. As depicted in FIG. 3, the inner circumferential surface of cavity 43 includes a first channel 46 that receives the first convex portion 31 and a second channel 47 that receives the second convex portion 32. The first channel 46 and the second channel 47 are recessed at positions that are side by side on both left and right sides (that is, both sides in the circumferential direction) of an upper end of the inner circumferential surface of the cavity 43.

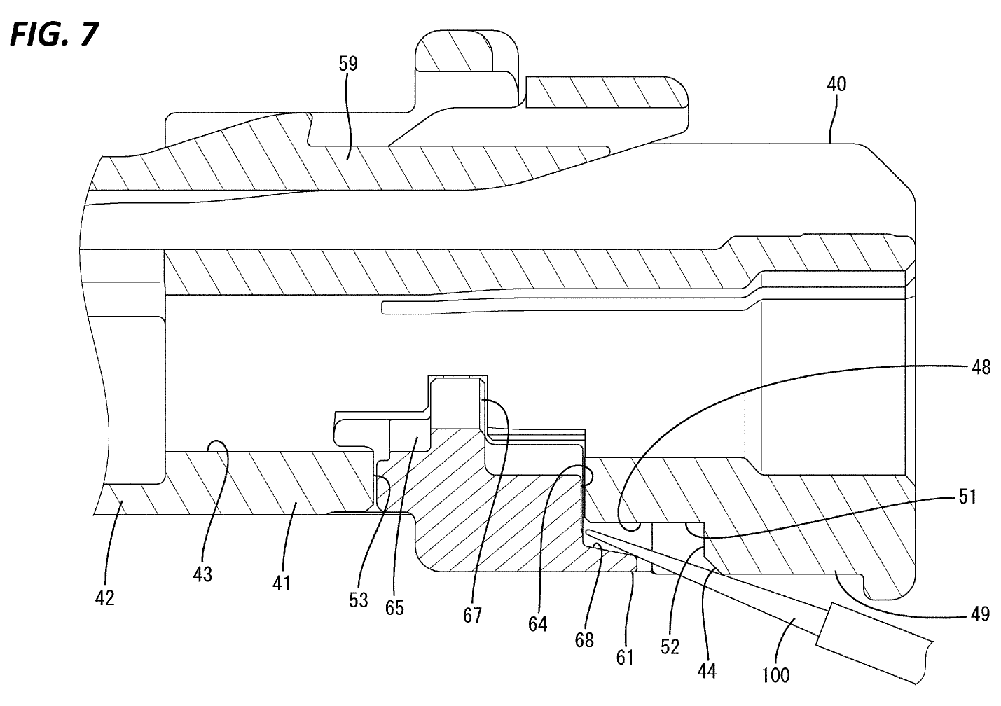

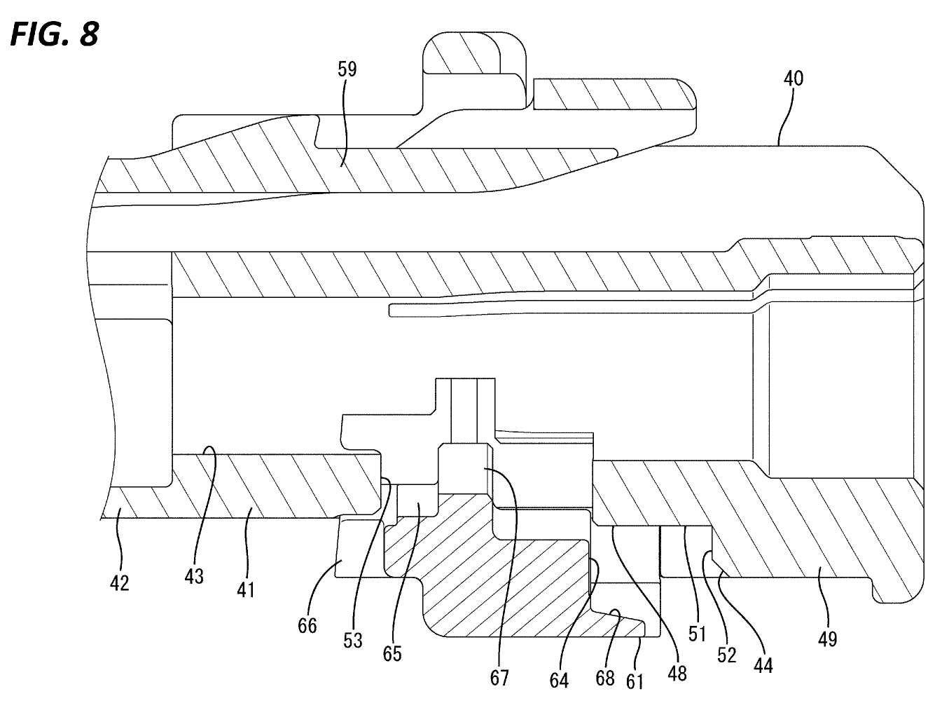

The housing main body 41 includes a mounting hole 53 that intersects the cavity 43. As depicted in FIGS. 7 and 8, the mounting hole 53 is formed to extend from a lower surface (or "one surface" for the present disclosure) of the housing main body 41 to an intermediate position in the front-rear direction of the cavity 43. In short, the mounting hole 53 passes through the lower end of the housing main body 41 in the up-down direction. The retainer 60 is inserted into this mounting hole 53 from below the housing main body 41. A part of the lower surface of the housing main body 41 in the periphery of the opening of the mounting hole 53 forms a flat facing surface 48 that faces a base portion 61, described later, of the retainer 60.

A stepped portion 49 is formed at the rear end of the lower surface of the housing main body 41 so as to protrude downward from a position further forward than the rear end. The facing surface 48 is continuous with an inner surface (described later) of the stepped portion 49. Out of a lower end portion of the housing main body 41 (that is, a part below the cavity 43), the part that corresponds to the stepped portion 49 is formed thicker than other parts that are closer to the front. As depicted in FIGS. 4 and 9, a pair of recesses 51 are formed in the stepped portion 49 so as to be spaced apart in the left-right direction.

As depicted in FIG. 4, each recess 51 is formed in a square U-shape when viewed from below. Each recess 51 has a depth in the up-down direction that is equivalent to the protruding dimension of the stepped portion 49. As depicted in FIGS. 7 and 8, the innermost surface in the up-down direction of each recess 51 (the surface that faces downward at the top of each recess 51) is continuous with the facing surface 48 with no change in height. The front ends of the recesses 51 are open at the front surface of the stepped portion 49. The rear ends of the recesses 51 form blocking surfaces 52 that are vertical and face the front. Corners (that is, edges of the openings) where the blocking surface 52 of each recess 51 intersects a lower surface of the stepped portion 49 are each formed into a jig contact portion 44 that is chamfered into the shape of an inclined surface (or "bevel").

Each jig contact portion 44 slopes upward from the lower surface of the stepped portion 49 toward the facing surface 48. As depicted in FIG. 7, a jig 100 for releasing the locking of the retainer 60 (described later) is placed against the jig contact portions 44 and can be rotated about the jig receiving portions 44 as a pivot. The recess 51 and the jig contact portion 44 are configured as "jig receiving portions" 44 and 51 that receive the jig 100.

As depicted in FIG. 2, a lance 54 is formed on the lower end portion of the housing main body 41. As depicted in FIG. 4, the lance 54 protrudes forward in a cantilevered state from the rear end of the mounting hole 53. The lance 54 faces the mounting hole 53 and defines left and right intermediate parts of the mounting hole 53. The lance 54 is elastically deformable in the up-down direction, with its base side, which corresponds to the rear end of the mounting hole 53, as a pivot.

A lower surface of the lance 54 and the facing surface 48 are continuous in the front-rear direction with no change in height. A reinforcing portion 45 is formed at the rear end of the lower surface of the lance 54. The reinforcing portion 45 is formed in a rib shape from the rear end side of the lower surface of the lance 54 across the facing surface 48. The reinforcing portion 45 gradually becomes thicker toward the rear. The rear end of the reinforcing portion 45 is connected to a position between the recesses 51 on the front surface of the stepped portion 49. The resilience of the lance 54 can be adjusted using the reinforcing portion 45.

As depicted in FIG. 2, a locking projection 55 is formed on a tip (front end) of the lance 54. The locking projection 55 protrudes from an intermediate position in the front-rear direction of the interior of the cavity 43. In a state where the terminal 20 has been inserted into the cavity 43, the locking projection 55 advances into the constricted portion 29 and faces the rear end of the second outer conductor 27, enabling the locking projection 55 to lock the terminal 20. The terminal 20 is locked by the locking projection 55, which primarily suppresses the terminal from coming out from the cavity 43.

As depicted in FIG. 4, an overhanging portion 81 having a rectangular plate shape is formed on the lower end portion of the housing main body 41 so as to protrude to the rear from the front end of the mounting hole 53. A tip (here, the rear end) of the overhanging portion 81 and the tip (here, the front end) of the lance 54 face each other with an interval in between in the front-rear direction in the mounting hole 53. Due to the mounting hole 53 including the lance 54 and the overhanging portion 81, the mounting hole 53 is open in an H-shape in the lower surface (or "facing surface") 48 of the housing main body 41. A shallow recess 82 is formed in a lower surface (outer surface) of the overhanging portion 81. The recess 82 is recessed in a rectangular shape in a bottom view and is provided in an intermediate position in the left-right direction of the lower surface of the overhanging portion 81. The recess 82 is an opening in the rear surface of the overhanging portion 81 and faces the tip of the lance 54 from behind. As depicted in FIG. 2, the recess 82 has a function of receiving a jig 110 for releasing the locking of the lance 54 and guiding the jig 110 to the lance 54.

As depicted in FIGS. 1 and 3, a pair of mounting surfaces 56 are formed on outer surfaces (side surfaces) on both the left and right sides of the housing main body 41. The mounting surfaces 56 are disposed on both sides of the housing main body 41 at positions that are recessed from adjacent portions along the front-rear and up-down directions. Protruding locking portions 57, 58 for provisional locking and full locking are formed on each mounting surface 56. The locking portions 57, 58 are formed in rib shapes that extend in the front- rear direction and are disposed next to each other in the up-down direction. The locking portions 58 for full locking are disposed at higher positions than the locking portions 57 for provisional locking. Side portions 62 (described later) of the retainer 60 are disposed to face and cover the mounting surfaces 56. The locking portions 57 and 58 have a function of locking locked portions 63 (described later) of the retainer 60 to hold the retainer 60 at a provisionally locked position and a fully locked position, respectively, on the housing 40.

### Retainer 60

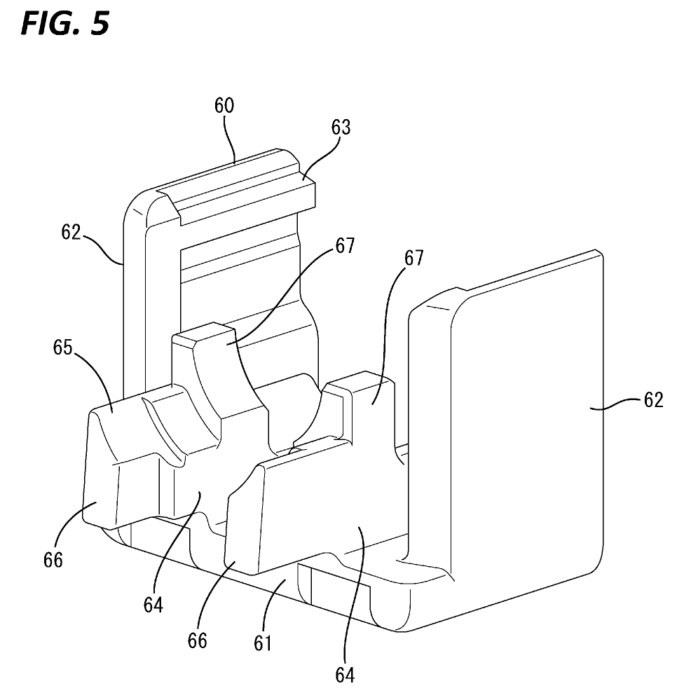

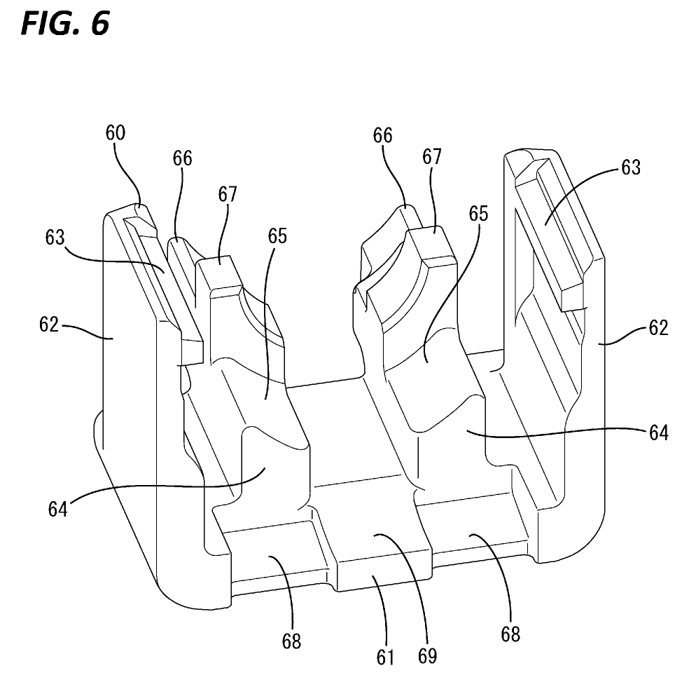

The retainer 60 is molded from an electrically insulating synthetic resin material. As depicted in FIGS. 5 and 6, the retainer 60 includes the base portion 61, which is shaped as a rectangular plate in a bottom view, and the pair of left and right side portions 62, which are erected on the left and right ends of the base portion 61. Each side portion 62 is shaped like a rectangular plate in a side view. The retainer 60 is disposed on the housing 40 so as to be movable between the provisional locking position and the full locking position. As depicted in FIG. 8, when the retainer 60 is at the provisional locking position, the base portion 61 is disposed spaced downward apart from the facing surface 48 of the housing main body 41. As depicted in FIGS. 2, 3 and 7, when the retainer 60 is at the full locking position, the base portion 61 is disposed close to the facing surface 48 of the housing main body 41. The upper surface of the base portion 61 is an inner surface that faces the cavity 43. As depicted in FIG. 2, since the lance 54 is covered by this base portion 61, excessive downward bending of the lance 54 is suppressed.

As depicted in FIG. 3, the side portions 62 are disposed so as to cover the mounting surfaces 56 at the full locking position. A pair of left and right locked portions 63 are formed to protrude from inner surfaces (which face each other) of upper end portions of the side portions 62. As depicted in FIG. 6, each locked portion 63 has a rib shape that extends in the front-rear direction on the inner surface of the upper end portions of the side portions 62. By positioning the locked portions 63 between the locking portions 57 and 58, the retainer 60 is held at the provisionally locked position on the housing 40. As depicted in FIG. 3, by disposing the locked portions 63 above the locking portions 58 for full locking and placing the base portion 61 so as to face and be able to contact the facing surface 48 of the housing main body 41 from below, the retainer 60 is held at the full locking position on the housing 40.

As depicted in FIGS. 5 and 6, the retainer 60 includes a pair of left and right protruding wall portions 64 that protrude from the upper surface of the base portion 61 on both the left and right sides. Each protruding wall portion 64 is disposed facing the outer circumferential surface of the outer conductor 22 from below. The protruding wall portions 64 are wall-shaped and have wall surfaces that face the left and right directions. These wall surfaces of the protruding wall portions 64 face the inner wall surfaces of the side portions 62 on the right and left with gaps in between. As depicted in FIG. 3, an upper end surface of each protruding wall portion 64 is formed into a bearing surface 65 that curves in an arc shape along the outer circumferential surface of the outer conductor 22. As depicted in FIG. 5, the protruding wall portions 64 are formed with a pair of left and right protruding pieces 66 that protrude forward from the base portion 61. When the retainer 60 is at the full locking position, the overhanging portion 81 is positioned so as to be sandwiched between these protruding pieces 66.

A pair of left and right retaining portions 67 are formed so as to protrude from intermediate positions in the front-rear direction on the bearing surfaces 65 of the projecting wall portions 64. The upper end surface of each retaining portion 67 is curved in an arc shape along the outer circumferential surface of the constricted portion 29 of the first outer conductor 26. The front surface of each retaining portion 67 is disposed along the up-down direction. When the retainer 60 is at the provisional locking position, each retaining portion 67 is positioned below the intermediate part in the front-rear direction of the cavity 43 (that is, the space into which the terminal 20 is inserted), which allows the terminal 20 to be inserted into the cavity 43. When the retainer 60 is at the full locking position, each retaining portion 67 enters the constricted portion 29 and faces the rear end of the second outer conductor 27, which enables the terminal 20 to be locked. By doing so, the terminal 20 is secondarily prevented from coming out of the cavity 43 to the rear.

As depicted in FIG. 6, the retainer 60 includes a pair of left and right jig engagement portions 68 on the upper surface of the base portion 61. The jig engagement portions 68 are formed in symmetrical shapes at positions on the upper surface of the base portion 61 that are on the left and right sides of the center in the left-right direction and to the rear of the retaining portions 67. In more detail, each jig engagement portion 68 is recessed on both left and right sides of the upper surface of the base portion 61. The rear ends of the jig engagement portions 68 are exposed at positions that are somewhat recessed from the rear surface of the base portion 61. The front inner surfaces of the jig engagement portions 68 (that is, the surfaces at the front that face the rear) are continuous with the rear surfaces of the protruding wall portion 64 in the up-down direction with no change in height. The left-right spacing between the jig engagement portions 68 is equal to the spacing between the protruding wall portions 64 that face each other in the left-right direction. A concave surface portion 69, in the form of a concave surface, is formed on the upper surface of the base portion 61 at a position between the jig engagement portions 68. As depicted in FIG. 2, when the retainer 60 is at the full locking position, the reinforcing portion 45 faces the concave surface portion 69 and is capable of coming into contact with the concave surface portion 69.

As depicted in FIG. 6, the width of the opening in the left-right direction of each jig engagement portion 68 is greater than the wall thickness in the left-right direction of each protruding wall portion 64. As depicted in FIGS. 7 and 8, the bottom surfaces (that is, surfaces at the bottom that face upward) of the jig engagement portions 68 are upwardly inclined toward the front. The angle of inclination (the angle of inclination relative to the front-rear direction) of the bottom surfaces of the jig engagement portions 68 is smaller than the angle of inclination of the jig contact portions 44.

### Operation of Connector 10

Before the terminal 20 is assembled, the locked portions 63 may be locked on the locking portions 58 for full locking so that the retainer 60 is held on the housing 40 at the full locking position in a state where movement to the provisional locking position is prevented. As depicted in FIG. 7, when the retainer 60 is at the full locking position, the front inner surfaces of the jig engagement portions 68 (that is, the surfaces that are continuous with the rear surfaces of the protruding wall portions 64) are disposed facing the front of the recesses 51. The bottom surfaces of the jig engagement portions 68 and the facing surface 48 are spaced apart in the up-down direction. The jig contact portions 44 are disposed facing the jig engagement portions 68 via a clearance formed between the jig contact portions 44 and the rear ends of the jig engagement portions 68 (the front-rear gap formed between reference numerals 44 and 61 in FIG. 7). The recesses 51 are downwardly exposed via this clearance. In this state, a jig 100 for releasing the locking of the retainer 60 is used to move the retainer 60 to the provisionally locked position.

As depicted in FIG. 7, the front end of the jig 100 is inserted into the recess 51 from below the housing main body 41 and becomes disposed inside the recess 51 facing diagonally upward toward the front between a front portion of an inner surface of the recess 51 and the jig engagement portions 68. The front end of the jig 100 contacts the rear end of the jig contact portions 44 (that is, the corners that intersect the lower surface of the stepped portion 49) at a position to the rear of the part inserted into the recess 51. In this state, a force is applied to the jig 100 to rotate the jig 100 around the jig contact portions 44 as a pivot. When this happens, the front end of the jig 100 presses against the bottom surfaces of the jig engagement portions 68, causing the side portions 62 to elastically widen, which releases the locking of the locked portions 63 and the locking portions 58. Additionally, as the jig 100 rotates about the jig contact portions 44 as a pivot, the jig engagement portions 68 are pushed downward by the front end of the jig 100, so that the retainer 60 is moved from the full locking position toward the provisional locking position. When the retainer 60 reaches the provisional locking position, the locked portions 63 lock onto the locking portions 57 for provisional locking, which prevents the retainer 60 from moving. At this point, the front end of the jig 100 is removed from the recess 51 (see FIGS. 8 and 9).

In the description above, a flat-head screwdriver or the like can be used as the jig 100. Here, as one example, the jig 100 can be separately applied to the jig engagement portions 68 on the left and right sides to sequentially release the locking between the locking portions 58 and the locked portions 63 on both the left and right sides. However, it is also possible to use a U-shaped jig with two active parts, so that the jig acts on the jig engagement portions 68 on both the left and right sides simultaneously to release the locking between the locking portions 58 and the locked portions 63 on both the left and right sides at once.

In this way, by rotating the jig 100 using the jig contact portions 44 as a pivot so as to make use of the principle of leverage, the retainer 60 can be easily moved from the full locking position to the provisional locking position. In particular, in the case of the first embodiment, since the jig engagement portions 68 are formed on both the left and right sides of the base portion 61, the jig 100 can be positioned closer to the locked parts of the locking portions 58 and the locked portions 63 than when a jig engagement portion 68 is formed in the center in the left-right direction of the base portion 61. Accordingly, the operating force of the jig 100 is efficiently transmitted to the locked parts, which enables the locking between the locking portions 58 and the locked portions 63 to be smoothly released. Also, since the jig engagement portions 68 are provided on both sides of the base portion 61 on both sides of the lance 54 in the left-right direction, it is possible to prevent the front end of the jig 100 from coming into contact with the lower surface of the lance 54, which prevents the lower surface of the lance 54 from being damaged by the front end of the jig 100.

In a state where the retainer 60 is held on the housing 40 at the provisional locking position, the terminal 20 is inserted into the cavity 43 of the housing 40 from the rear. The retainer 60 is then moved to the full locking position. The terminal 20 is doubly locked by the lance 54 and the retaining portions 67, and is reliably held and prevented from coming out of the cavity 43 of the housing 40.

When removing the terminal 20 from the cavity 43 of the housing 40, for reasons such as maintenance, first, using the procedure described earlier, the jig 100 for releasing the locking of the retainer 60 is operated on the jig engagement portions 68 through the jig receiving portions 44, 51 to move the retainer 60 from the full locking position to the provisional locking position. In this state, the jig 110 for releasing the locking of the lance 54 depicted in FIG. 2 is operated on the front end of the lance 54 through the recess 82 in the overhanging portion 81. The lance 54 is caused to elastically deform downward by the jig 110, which releases the locking between the terminal 20 and the locking projection 55. When the lance 54 is in the elastically deformed state, the shielded wire 90 is pulled to the rear to remove the terminal 20 from the cavity 43.

As described above, the connector 10 according to the first embodiment includes the terminal 20, the housing 40 that accommodates the terminal 20, and the retainer 60 that is attached to the housing 40. The housing 40 includes a cavity 43 that extends in the front-rear direction, the attachment hole 53 that intersects the cavity 43 and is an opening in a lower surface that serves as one surface of the housing 40, and locking portions (the locking portions 58 for full locking) provided on the pair of left-right side surfaces that intersect the lower surface of the housing 40. The terminal 20 is disposed in the cavity 43. The retainer 60 includes the base portion 61 that is placed in the mounting hole 53 through the opening in the lower surface of the housing 40, the pair of side portions 62 that protrude from the base portion 61 and face a pair of side surfaces of the housing 40, the locked portions 63 provided on the pair of side portions 62, and the retaining portions 67 that protrude from the base portion 61 and are located between the pair of side portions 62 in the left-right direction. The locking portions 58 lock onto the locked portions 63 to hold the retainer 60 on the housing 40. The retaining portions 67 lock the terminal 20, which prevents the terminal 20 from coming out from the cavity 43 to the rear. The base portion 61 includes the pair of jig engagement portions 68 on both left and right sides of the upper surface, which forms an inner surface facing the cavity 43. The housing 40 has a pair of jig receiving portions 44, 51, which face the pair of jig engagement portions 68, at positions on both the left and right sides of the lower surface.

As described above, the locking between the locking portions 58 and the locked portions 63 can be released by the jig receiving portions 44, 51 receiving the jig 100 so that the front end of the jig 100 engages the jig engagement portions 68. In particular, since the position that engages the front end of the jig 100 is the base portion 61 and not the side portions 62, it is possible to avoid the front end of the jig 100 from coming into contact with the locked parts of the locking portions 58 and the locked portions 63. In addition, since the engagement positions of the front end of the jig 100 are positions on the base portion 61 that are close to the pair of side portions 62, the operating force of the jig 100 can be efficiently transmitted to the locked parts, which makes it easy to release the locking of the retainer 60 on the housing 40.

The pair of jig receiving portions 44, 51 include the jig contact portions 44 at corners of the stepped portion 49 that protrudes from the lower surface of the housing 40. This enables the jig to be rotated using the principle of leverage, with the jig contact portions 44 as the pivot. As a result, it is easier to release the locking of the retainer 60.

The housing 40 also includes the lance 54 that is elastically deformable and engages the terminal 20. The lance 54 faces the mounting hole 53 and is disposed between the pair of jig receiving portions 44, 51 in the left-right direction. This prevents the front end of the jig 100 from coming into contact with the lance 54, which enables the lance 54 to function properly.

In addition, the terminal 20 is a shielded terminal including the inner conductor 21, the dielectric 23 that accommodates the inner conductor 21, and the outer conductor 22 that accommodates the dielectric 23. The retaining portions 67 lock the outer conductor 22. According to the first embodiment, as described earlier, the locking portion 58 is less likely to break and the retainer 60 can be stably locked onto the housing 40. This makes it possible to suppress positional fluctuations of the outer conductor 22 locked by the retaining portions 67, which enables the terminal 20 to achieve the desired shielding properties.

### Other Embodiments of Present Disclosure

The first and second embodiments described here should be regarded as exemplary in all respects and do not limit the present disclosure.

In the case of the present embodiment, the terminal is a shielded terminal including the inner conductor, the outer conductor, and the dielectric. In contrast, in other embodiments, the terminal may be a typical terminal that does not include a dielectric and made entirely of a conductive metal plate material.

In the case of the first embodiment, the jig contact portion has a beveled surface with a chamfered corner on a stepped portion that protrudes from the lower surface of the housing. In contrast, according to another embodiment, the jig contact portion may have an angular shape where the corner of the stepped portion that protrudes from the lower surface of the housing is not chamfered. The jig contact portion may have a rounded surface produced by chamfering the corner of the stepped portion that protrudes from the lower surface of the housing.

In the first embodiment, the jig receiving portion is composed of a recess and a jig engagement portion. In contrast, as another embodiment, the jig receiving portion may omit a recess and may simply be composed of the corner of a stepped portion as a jig contact portion.

In the first embodiment, the jig engagement portion is recessed in an upper surface, which is an inner surface of the base portion that faces the cavity. In contrast, as another embodiment, the jig engagement portion may be any part that comes into contact with and is pressed by the front end of the jig, and as one example, instead of being recessed in the upper surface of the base, the jig engagement portion may be a surface that is continuous with part of a circumferential surface that is an upper surface without no change in height.

In the first embodiment, the retainer is disposed on the housing so as to be capable of moving between the provisional locking position and the full locking position. Alternatively, the retainer may be designed so that the retainer does not remain at a provisional locking position on the housing but is locked at a position corresponding to the full locking position. In this case, there is no need to provide locking portions for provisional locking on the housing, and it is possible to use a configuration where locking between locking portions corresponding to locking portions for full locking and the locked portions is released by a jig that engages with the jig engagement portions, which enables the retainer to be removable from the housing.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising a terminal, a housing that accommodates the terminal, and a retainer that is attached to the housing,
wherein the housing includes: a cavity that extends in a front-rear direction, a mounting hole that intersects the cavity and is open in one surface of the housing, and locking portions provided on a pair of side surfaces of the housing that intersect the one surface and face left and right directions,
the terminal is disposed in the cavity,
the retainer includes: a base portion that is placed in the mounting hole through the opening in the one surface; a pair of side portions that protrude from the base portion and face the pair of side surfaces; locked portions that are provided on the pair of side portions; and a retaining portion that is positioned between the pair of side portions in the left-right direction and protrudes from the base portion,
the locking portions lock the locked portions, the retainer is held on the housing, and the retaining portion locks the terminal to prevent the terminal from coming out from the cavity to the rear,
the base portion includes a pair of jig engagement portions at positions on both left and right sides of an inner surface on the cavity side, and
the housing includes a pair of jig receiving portions, which face the pair of jig engagement portions, at positions on both sides in the left-right direction on the one surface.

2. The connector according to claim 1,
wherein the pair of jig receiving portions include jig contact portions at a corner of a stepped portion that protrudes from the one surface.

3. The connector according to claim 1,
wherein the housing includes a lance that is elastically deformable and locks the terminal, and
the lance faces the mounting hole and is disposed between the pair of jig receiving portions in the left-right direction.

4. The connector according to claim 1,
wherein the terminal is a shielded terminal including an inner conductor, a dielectric that accommodates the inner conductor, and an outer conductor that accommodates the dielectric, and
the retaining portion locks the outer conductor.
